(19) United States
(12) Patent Application Publication
(10) Pub. No.: US 2009/0128739 A1
(43) Pub. Date: May 21, 2009

(54) LIGHT DIFFUSER PLATE WITH LIGHT-COLLECTING LAYER

(75) Inventors: Hiroyuki KUMASAWA, Ehime (JP); Akiyoshi Kanemitsu, Ehime (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Tokyo (JP)

(21) Appl. No.: 12/270,976

(22) Filed: Nov. 14, 2008

(30) Foreign Application Priority Data
Nov. 16, 2007 (JP) 2007-297443

(51) Int. Cl. G02F 1/1335; G02B 5/02

(52) U.S. Cl. 349/64; 359/599

(57) ABSTRACT

There is provided a light diffuser plate with a light-collecting layer, which is sufficiently prevented from flawing and which is used to make it possible to sufficiently ensure a luminance in a forward direction.

A light diffuser plate 3 with a light-collecting layer, according to the present invention, comprises a light-diffusing substrate 31 and a light-collecting sheet 32, which are disposed to be superposed on each other, and is wherein the light-diffusing substrate 31 and the light-collecting sheet 32 are jointed to each other by joint portions 34 which are so disposed as to be scattered over a whole plane of the light diffuser plate, and wherein an air layer 33 exists between the light-diffusing substrate 31 and the light-collecting sheet 32, in an area other than the joint portions 34.

### FIELD OF THE INVENTION

This application was filed claiming Paris Convention priority of Japanese Patent Application No. 2007-297443, the entire content of which is herein incorporated by reference.

The present invention relates to a light diffuser plate with a light-collecting layer, which can be sufficiently prevented from flawing and which is used to make it possible to ensure a sufficient luminance in a forward direction, a high quality surface light source showing a sufficient luminance in a forward direction, and a liquid crystal display.

### BACKGROUND OF THE INVENTION

For example, a generally known liquid crystal display comprises a liquid crystal panel (or an image display member) including a liquid crystal cell, and a surface light source disposed as a backlight on the rear side of the liquid crystal panel. As the surface light source for a backlight, there is known a surface light source which comprises a lamp box (or a casing), a plurality of light sources disposed in the lamp box, a light diffuser plate disposed on the front side of these light sources, and lenticular lenses, i.e., a light-collecting sheet, disposed on the front side of the light diffuser plate. For example, Patent Document 1 discloses a surface light source having such a structure.
Patent Document 1: Japanese Patent Registration No. 3123006

### DISCLOSURE OF THE INVENTION

### PROBLEM TO BE SOLVED BY THE INVENTION

However, the surface light source having the above-described structure suffers from the following disadvantage: that is, the light diffuser plate and the light-collecting sheet rub on each other and thus are susceptible to flawing, because the light-collecting sheet is simply superposed on the front side of the light diffuser plate.

The present invention has been developed in consideration of the foregoing technical background. Objects of the present invention are therefore to provide a light diffuser plate with a light-collecting layer, which can be sufficiently prevented from flawing and which is used to make it possible to ensure a sufficient luminance in a forward direction, and to provide a high quality surface light source capable of showing a sufficient luminance in a forward direction, and a liquid crystal display comprising the same.

### MEANS FOR SOLVING THE PROBLEM

The present invention provides the following in order to achieve the above-described objects.

[1] A light diffuser plate with a light-collecting layer, comprising a light-diffusing substrate and a light-collecting sheet, which are disposed to be superposed on each other, wherein the light-diffusing substrate and the light-collecting sheet are jointed to each other by joint portions which are so disposed as to be scattered over a whole plane of the light diffuser plate, and wherein an air layer exists between the light-diffusing substrate and the light-collecting sheet in an area other than the joint portions.

[2] The light diffuser plate with the light-collecting layer, according to the item 1, wherein the area of the joint portions in a planar view is from 0.01 to 5% of the superposed area of the light-diffusing substrate and the light-collecting sheet.

[3] A surface light source comprising the light diffuser plate with the light-collecting layer, according to the item 1 or 2, and a plurality of light sources disposed on the rear side of the light diffuser plate, wherein the light-collecting sheet of the light diffuser plate is placed so as to face the front side of the surface light source.

[4] A liquid crystal display comprising the light diffuser plate with the light-collecting layer, according to the item 1 or 2, a plurality of light sources disposed on the rear side of the light diffuser plate, and a liquid crystal panel disposed on the front side of the light diffuser plate, wherein the light-collecting sheet of the light diffuser plate is placed so as to face the front side of the liquid crystal display.

### EFFECT OF THE INVENTION

According to the invention of the item [1], the light-diffusing substrate and the light-collecting sheet are jointed to each other by the joint portions, and therefore, the light-diffusing substrate and the light-collecting sheet do not rub on each other, so that flawing of the light diffuser plate can be sufficiently prevented. Further, the air layer exists between the light-diffusing substrate and the light-collecting sheet in an area other than the joint portions, and thus, a luminance in the forward direction can be sufficiently ensured. Furthermore, the joint portions are so disposed as to be scattered over a whole plane of the light diffuser plate, and therefore, because of the formation of the joint portions, no influence are given on the optical function of the light diffuser plate with the light-collecting layer, so that any influence on the picture quality of a displayed image can be avoided.

According to the invention of the item [2], the area of the joint portions in a planar view is set to from 0.01 to 5% of the superposed area of the light-diffusing substrate and the light-collecting sheet. Therefore, a sufficient joint strength can be ensured, and any influence of the joint portions on a displayed image can be sufficiently eliminated.

According to the invention of the item [3], the light diffuser plate with the light-collecting layer suffers from no flaw. Therefore, high quality light can be obtained, and a surface light source capable of showing a high luminance in a forward direction can be provided.

According to the invention of the item [4], the light diffuser plate with the light-collecting layer suffers from no flaw, and thus, a high quality image can be obtained, and a liquid crystal display capable of showing a high luminance in a forward direction can be provided.

### BRIEF DESCRIPTION OF THE DRAWINGS

The present invention will be fully understood by the detailed description and the accompanying drawings, wherein:

FIG. 1 shows a schematic diagram illustrating a liquid crystal display according to an embodiment of the present invention.

FIG. 2 shows a perspective view of a light diffuser plate with a light-collecting layer, according to the embodiment of the present invention.

FIG. 3 shows a sectional view of the light diffuser plate with the light-collecting layer, taken along line X-X shown in FIG. 2.

FIG. 4 shows a sectional view of a light diffuser plate with a light-collecting layer, according to another embodiment of the present invention.

FIG. 5 shows a plurality of plan views of light diffuser plates with light-collecting layers, according to other embodiments of the present invention, wherein no light-collecting sheet is disposed so as to illustrate the patterns of the disposed joint portions.

### DESCRIPTION OF REFERENCE NUMERALS

1=a surface light source
2=a light source
3=a light diffuser plate
20=a liquid crystal panel
30=a liquid crystal display
31=a light-diffusing substrate
32=a light-collecting sheet
33=an air layer
34=a joint portion
Q=a forward direction (or a normal line direction)

### DETAILED DESCRIPTION OF THE INVENTION

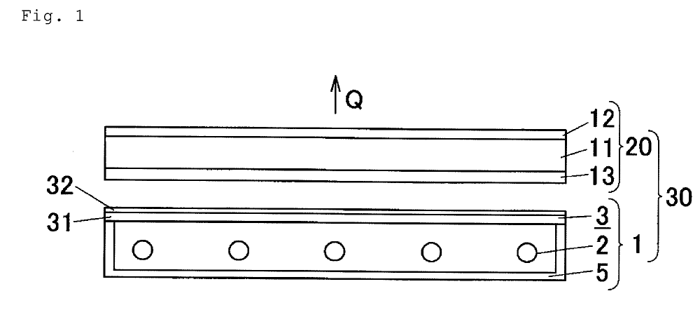

A liquid crystal display according to an embodiment of the present invention is shown in FIG. 1. In FIG. 1, a numeral (30) represents a liquid crystal display; (11), a liquid crystal cell; (12) and (13), polarizing plates; and (1), a surface light source (or a backlight). The polarizing plates (12) and (13) are disposed on the upper and lower sides of the liquid crystal cell (11), respectively, and these members (11), (12) and (13) constitute a liquid crystal panel (20) as an image display member. Preferable as the liquid crystal cell (11) is a liquid crystal cell capable of displaying a colored image.

The surface light source (1) is disposed on the lower side (or the rear side) of the lower polarizing plate (13) of the liquid crystal panel (20). That is, this liquid crystal display (30) is a direct type liquid crystal display.

The surface light source (1) comprises a low height casing-shaped lamp box (5) which is rectangular in its planar view and which is opened at its upper side (or front side), a plurality of light sources (2) disposed and spaced to one another at certain intervals in the lamp box (5), and a light diffuser plate (3) disposed on the upper side (or front side) of the plurality of light sources (2). The light diffuser plate (3) is so located as to close the opened face of the lamp box (5) and is fixed thereto. Further, a reflecting layer (not shown) is formed on the inner surfaces of the lamp box (5). While there is no limit in selection of the light sources (2), for example, cold cathode ray tubes, light-emitting diodes (LEDs) or the like are used.

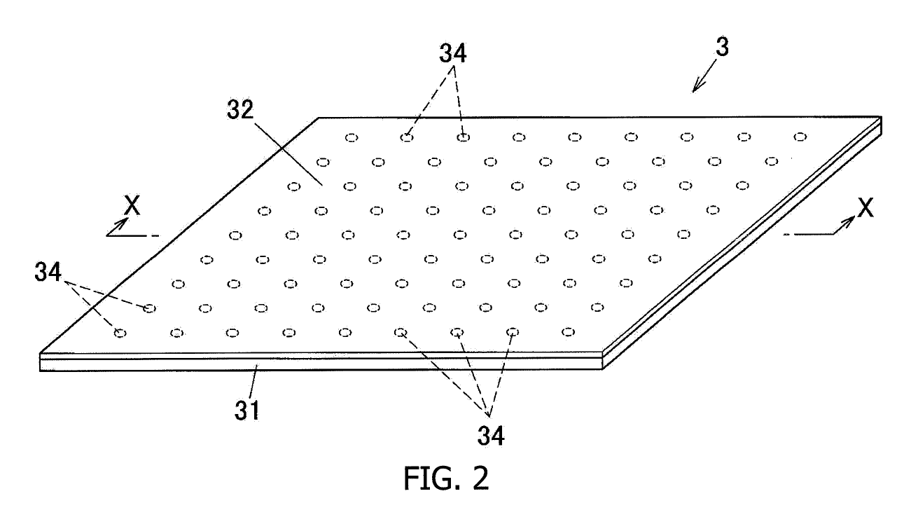

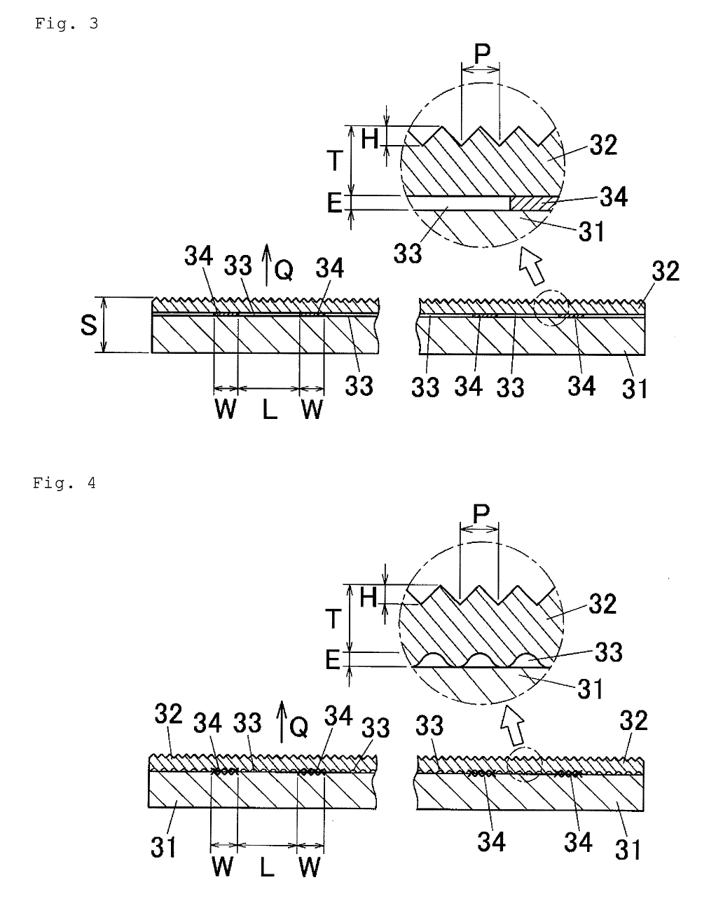

As shown in FIGS. 2 and 3, the light diffuser plate (3) comprises a light-diffusing substrate (31) and a light-collecting sheet (32), both of which are disposed in parallel to each other. The light-diffusing substrate (31) is jointed to the light-collecting sheet (32) by joint portions (34) which are so disposed as to be scattered over a whole of the joint surface in a planar view, and an air layer (33) exists between the light-diffusing substrate (31) and the light-collecting sheet (32), in an area other than the joint portions (34). In this embodiment, the light-diffusing substrate (31) and the light-collecting sheet (32) are jointed to each other by the joint portions (34) formed of an adhesive resin, which are so disposed as to be scattered over a whole of the joint surface in a planar view. Again, in this embodiment, the joint portions (34) are lots of substantially dot-shaped portions so disposed as to be scattered over a whole of the joint surface in a planar view. Again, in this embodiment, the light-diffusing substrate (31) and the light-collecting sheet (32) are disposed in a non-contact superposed state. In other words, they are superposed on each other but do not contact each other (see FIG. 3).

In the above-described liquid crystal display (30), the light diffuser plate (3) is disposed so that the light-collecting sheet (32) can be located on the front side of the light diffuser plate (i.e., on the side of the liquid crystal panel (20)) (see FIG. 1). In other words, in this liquid crystal display (30), the light diffuser plate (3) is disposed so that the light-diffusing substrate (31) can be located on the rear side of the light diffuser plate (i.e., on the side of the light sources (2)) (see FIG. 1).

Since the light-diffusing substrate (31) and the light-collecting sheet (32) are jointed to each other by the joint portions (34) in the above-described light diffuser plate (3), the light-diffusing substrate (31) and the light-collecting sheet (32) never rub on each other, so that the light diffuser plate (3) can be sufficiently prevented from flawing. Further, in the light diffuser plate (3), the air layer (33) exists between the light-diffusing substrate (31) and the light-collecting sheet (32), in an area other than the joint portions (34). Therefore, the surface light source (1) can illuminate with a high luminance in the forward direction (or the normal line direction) (Q), and an image can be displayed with a high luminance on the liquid crystal display (30) in the forward direction (or the normal line direction) (Q). Furthermore, since the joint portions (34) are so disposed as to be scattering over a whole of the joint surface in a planar view, the presence of the joint portions (34) does not give an adverse influence on the optical function of the light diffuser plate (3) with the light-collecting layer, which makes it possible to display an image with high picture quality.

In this embodiment, the light-diffusing substrate (31) and the light-collecting sheet (32) are jointed to each other by the joint portions (34) of the adhesive resin, so disposed as to be scattered over a whole of the joint surface in a planar view. However, this partial joint is not limited to such one formed of the adhesive resin. Any means may be employed, in so far as the light-diffusing substrate (31) and the light-collecting sheet (32) can be partially jointed to each other. In concrete, the light-diffusing substrate (31) and the light-collecting sheet (32) may be laminated on each other, for example, by laser welding, heat welding, ultrasonic welding, sewing with a yarn-like material, or using an adhesive tape, viscous particles or the like.

In the present invention, it is essential to form the air layer (33) between the light-diffusing substrate (31) and the light-collecting sheet (32), in an area other than the above-described joint portions (34). The term of “air layer” is used to also mean that the light-diffusing plate (31) and the light-collecting sheet (32) are not in optically tight contact with each other, although the diffusing plate (31) and the light-collecting sheet (32) are in contact with each other. This is described in detail: for example, as shown in FIG. 4, a light-collecting sheet (32) whose joint surface to be superposed is formed uneven is superposed on a light-diffusing substrate (31) in contact therewith, and both of them are jointed at joint portions (34) by welding, so that an air layer (33) exists on the joint surface area excluding the joint portions (34) between the light-diffusing plate (31) and the light-collecting sheet (32). In the arrangement shown in FIG. 4, the uneven surface of the light-collecting sheet (32) partially contacts the light-diffusing substrate (31) on the joint surface area excluding the joint portions (34). However, because of the uneven surface of the light-collecting sheet (32), the light-diffusing substrate (31) and the light-collecting sheet (32) are not in optically tight contact with each other, and thus, the air layer (33) exists between the diffusing plate (31) and the light-collecting sheet (32).

In this regard, a sufficient luminance can not be obtained in the forward direction (Q), when the light-diffusing plate (31) and the light-collecting sheet (32) are in optically tight contact with each other (in other words, no air layer exists therebetween).

In the present invention, as the light-diffusing substrate (31), any one that can diffuse transmitted light may be used. Above all, a plate comprising a transparent material and light diffuser particles (i.e., a light diffuser) dispersed therein is preferably used.

The transparent material for use in the light-diffusing substrate (31) is not particularly limited: for example, a transparent resin, an inorganic glass or the like is used. As the transparent resin, a transparent thermoplastic resin is preferably used because of its excellent molding facility. While there is no limit in selection of this transparent thermoplastic resin, examples thereof include polycarbonate resins, ABS resins (acrylonirile-butadiene-styrene copolymer resins), methacrylic resins, methyl methacrylate-styrene copolymer resins, polystyrene resins, AS resins (acrylonitrile-styrene copolymer resins), polyolefin resins (e.g., polyethylene resins, polypropylene resins, etc.) and the like.

There is no limit in selection of the above-described light diffuser particles: that is, there may be used any particles that are incompatible with the transparent resin constituting the light-diffusing substrate (31) and that have a different refractive index from the transparent resin. Examples of the light diffuser particles include inorganic particles such as silica particles, calcium carbonate particles, barium sulfate particles, titanium oxide particles, aluminum hydroxide particles, inorganic glass particles, mica particles, talc particles, white carbon particles, magnesium oxide particles and zinc oxide particles; and organic particles such as methacrylic crosslinked resin particles, methacrylic polymeric resin particles, styrene-based crosslinked resin particles, styrene-based polymeric resin particles and siloxane-based polymer particles. As the light diffuser particles, one kind selected from the above-listed particles may be used; or two or more kinds selected therefrom may be used as a mixture.

The light diffuser particles to be used are generally from 0.1 to 50 μm in volume-average particle diameter. The volume-average particle diameter (D₅₀) is determined as follows: the particle diameters and volumes of all the particles are measured; the volumes of the particles are integrated in order of their particle diameters, starting from the smallest particle diameter; and a particle found when such an integrated volume is equal to 50% of the total volume of all the particles is taken out, and the particle diameter of this particle is measured as the volume-average particle diameter (D₅₀).

The amount of the light diffuser particles to be used varies depending on an intended degree of diffusion of transmitted light. Generally, 0.01 to 20 parts by mass of the light diffuser particles are contained in 100 parts by mass of the transparent resin. Above all, it is preferable to contain 0.1 to 10 parts by mass of the light diffuser particles in 100 parts by mass of the transparent resin.

The thickness of the above-described light-diffusing substrate (31) is usually from 0.1 to 10 mm.

The above-described light-collecting sheet (32) is not limited. For example, there may be used a sheet or the like which has very fine light-collecting lenses such as very fine prism lenses, very fine convex lenses or lenticular lenses formed on its one overall surface. Transmitted light which passes through the light-diffusing substrate (31) while being diffused is converged by the light-collecting sheet (32) in the normal line direction (Q) of the light diffuser plate (3).

The material for the light-collecting sheet (32) is not limited. For example, there are given polycarbonate resins, ABS resins (acrylonitrile-butadiene-styrene copolymer resins), methacrylic resins, methyl methacrylate-styrene copolymer resins, polystyrene resins, AS resins (acrylonitrile-styrene copolymer resins), polyolefin resins (e.g., polyethylene resins, polypropylene resins, etc.) and the like. There is no limit in selection of commercially available product of the light-collecting sheet (32): for example, there are exemplified “BEF®” from SUMITOMO 3M LIMITED (which comprises a polyester film with a thickness of 125 μm and an acrylic resin layer with a thickness of 30 μm formed thereon, and which has V-shaped grooves with depths (H) of 25 μm and bottom open angles of 90° formed at pitch intervals (P) of 50 μm on the surface of the acrylic resin layer, as shown in FIG. 3), “Estina®” from SEKISUI CHEMICAL CO., LTD., etc.

The thickness (T) of the light-collecting sheet (32) is usually from 0.02 to 5 mm, preferably from 0.02 to 2 mm.

The thickness (E) of the air layer (33) is usually from 1 to 100 μm, preferably from 5 to 20 μm.

When the above-described joint portions (34) are formed of an adhesive resin, there is no limit in selection of this adhesive resin: for example, any of acrylic resins, urethane-based resins, polyether-based resins, silicone-based resins, epoxy-based resins and the like may be used. The use of a colorless and transparent resin selected from these resins is preferable, from the viewpoint of formation of a displayed image with higher quality. In this regard, the refractive index of this adhesive resin is not limited.

From the viewpoints of improving the joint strength, it is advantageous to increase the area of the joint portion (34) (the area in front view). However, desirably, the joint portion (34) should have such dimensions (i.e., the width, major axis, etc.) that are hard to be visually observed, from the viewpoint of sufficiently eliminating the influence of the joint portion (34) on a displayed image. In synthetic consideration of both the viewpoints, preferably, the area (in front view) of the joint portion (34) is set to from 0.01 to 5% of the total superposed area of the light-diffusing substrate (31) and the light-collecting sheet (32).

Preferably, the dimensions (W) of the joint portion (34) (i.e., the widths of lines, if this portion is formed in the shape of lines or lattice, or the major axes, etc., if it is dot-like formed) are set to from 50 μm to 3 mm. The dimensions of 50 μm or more make it possible to ensure a sufficient joint strength, and the dimensions of 3 mm or less make it possible to sufficiently eliminate the influence of the joint portion (34) on a displayed image.

Preferably, the interval (L) between each of adjacent joint portions (34) is set to from 3 to 10 cm. The interval of 3 cm or more makes it possible to sufficiently eliminate the influence of the joint portion (34) on a displayed image. The interval of 10 cm or less makes it possible to ensure a sufficient joint strength.

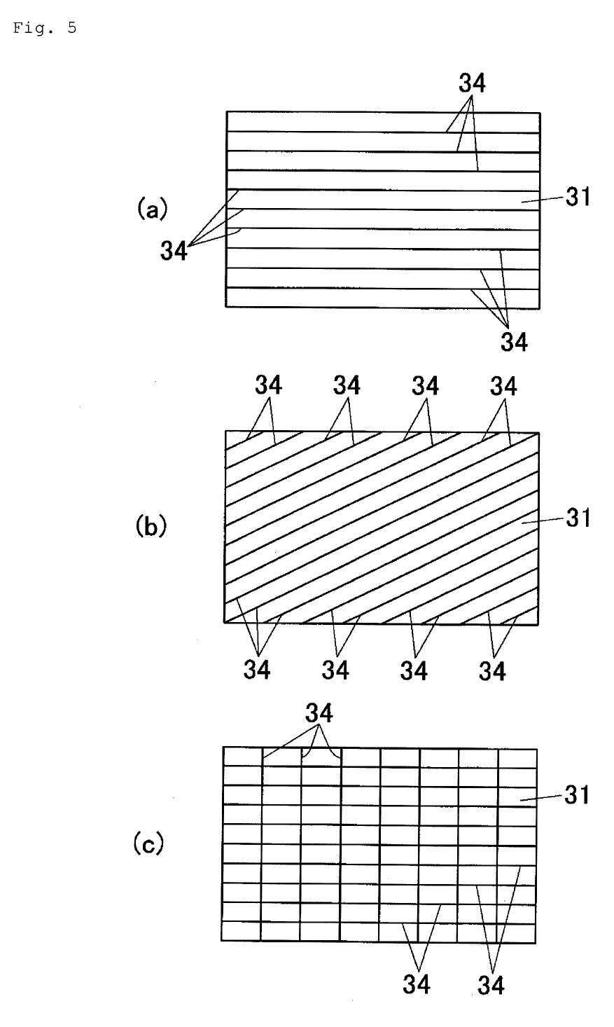

In this embodiment, the joint portions (34) are dot-like formed so that lots of substantially dot-shaped portions are scattered over a whole of the joint surface area, when viewed from just above. However, the arrangement of the joint portions (34) is not limited to this one, and any arrangement is allowed, in so far as the joint portions (34) are disposed to be scattered over a whole of the joint surface area, when viewed from just above: for example, as shown in FIG. 5(a) or 5(b), the joint portions (34) in the shapes of stripes may be linearly arranged; or as shown in FIG. 5(c), the joint portions (34) may be lattice-like arranged in a planar view.

Preferably, any one of the above-described light-collecting sheet (32) and the above-described light-diffusing substrate (31) should be formed uneven at its joint surface, in order to prevent the optically tight contact between the light-collecting sheet (32) and the light-diffusing substrate (31), even when both of them contact to each other, in other words, in order to ensure the formation of the air layer (33) between the light-collecting sheet (32) and the light-diffusing substrate (31), even when both of them contact to each other. The ten-point height of irregularities Rz of this uneven surface (in accordance with the regulation of JIS B0601-2001) is preferably from 1.0 to 100 μm, particularly from 1.0 to 50 μm.

The light diffuser plate (3) of the present invention may be fabricated by heat press using, for example, the above-described adhesive resin, or may be fabricated by thermowelding. However, these methods are illustrative only, and the light diffuser plate (3) of the present invention is not limited to ones fabricated by these methods in any way.

The thickness (S) of the light diffuser plate (3) of the present invention is generally from 0.1 to 15 mm. The dimensions (or the area) of the light diffuser plate (3) of the present invention are not limited: for example, the dimensions may be appropriately selected in accordance with the dimensions of an intended surface light source (1) or an intended liquid crystal display (30). However, the dimensions of the light diffuser plate are generally from 20 cm×30 cm to 150 cm×200 cm.

The light diffuser plate (3), the surface light source (1) and the liquid crystal display (30) of the present invention are not limited to those of the foregoing embodiments, and may be altered or modified in their designs, to an extent that such altered or modified ones are allowed within the scope of the claims without departing from the spirit of the present invention.

### EXAMPLES

Next, concrete examples of the present invention will be described, which, however, should not be construed as limiting the scope of the present invention in any way.

### Example 1

There was used a light-diffusing substrate (31) with a thickness of 2.0 mm, which had a total light transmittance of 70%, measured according to JIS K-7361, and which had an upper uneven surface (that is, an uneven surface having Rz of 1.79 μm according to JIS B0601-2001). An acrylic resin adhesive was dot-like applied to the upper uneven surface of the light-diffusing substrate (31), so that lots of substantially dot-shaped portions of the adhesive could be so formed as to be scattered over a whole of the surface of the substrate, when viewed from just above (see FIG. 2). After that, a light-collecting sheet (32) was superposed on this uneven surface of the light-diffusing substrate (31) and was pressed thereonto. Thus, there was fabricated a light diffuser plate (3) as shown in FIGS. 2 and 3, which comprised the light-diffusing substrate (31) and the light-collecting sheet (32) superposed on and jointed to each other by the joint portions (34) which were so disposed as to be scattered over a whole of the joint surface area when viewed from just above.

In this regard, the major axis (W) of the dot as the joint portion (34) was 2.0 mm, and the interval (L) between each of adjacent dots was 3.0 cm. Used as the light-collecting sheet (32) was “BEF®” manufactured by SUMITOMO 3M LIMITED (i.e., a polyester film with a thickness of 125 μm having an acrylic resin layer with a thickness of 30 μm formed thereon, the acrylic resin layer having V-shaped grooves with depths (H) of 25 μm and bottom open angles of 90°, formed at pitch intervals (P) of 50 μm on its surface, as shown in FIG. 3).

In the light diffuser plate (3) thus obtained, the thickness (E) of an air layer (33) was 10 μm, and the ratio of the area of the joint portion (34) to the entire superposed area of the light-diffusing substrate (31) and the light-collecting sheet (32) was 0.2%.

Next, a surface light source (1) having the above-described structure shown in FIG. 1 was fabricated, using the light diffuser plate (3). As light sources (2), cold cathode ray tubes were used. The luminance of the surface light source (1) in the forward direction (or the normal line direction) (Q) was measured, and it was found to be 7,409 cd/m².

### Comparative Example 1

An acrylic resin adhesive was applied to the entire upper surface of the above-described light-diffusing substrate, and then, the above-described light-collecting sheet (“BEF®” manufactured by SUMITOMO 3M LIMITED) was superposed on and pressed onto this upper surface of the light-diffusing substrate. Except for this procedure, a surface light source was fabricated in the same manner as in Example 1. The luminance of this surface light source in the forward direction was measured, and it was found to be 5,263 cd/m².

### Reference Example 1

The above-described light-collecting sheet (“BEF®” manufactured by SUMITOMO 3M LIMITED) was simply superposed on the upper surface of the light-diffusing substrate (i.e., an air layer was formed between the light-diffusing substrate and the light-collecting sheet). Except for this procedure, a surface light source was fabricated in the same manner as in Example 1. The luminance of this surface light source in the forward direction was measured, and it was found to be 7,427 cd/m².

As described above, the surface light source of Example 1, fabricated using the light diffuser plate of the present invention, could obtain a sufficiently high luminance in the forward direction (or the normal line direction). That is, this surface light source could obtain a sufficiently high luminance of the same level as that of the luminance of the conventional surface light source of Reference Example 1 in which the light-collecting sheet was simply superposed on the light-diffusing substrate. Further, in the light diffuser plate of Example 1, the light-diffusing substrate and the light-collecting sheet were jointed to each other by the joint portions, and thus, the light-diffusing substrate and the light-collecting sheet did not rub on each other, so that the light diffuser plate suffered from no flaw.

In contrast, the surface light source of Comparative Example 1 had no air layer between the light-diffusing substrate and the light-collecting sheet because of the application of the adhesive to the entire surface of the light-diffusing substrate. Accordingly, this surface light source could not obtain a sufficient luminance in the forward direction (or the normal line direction).

### INDUSTRIAL APPLICABILITY

While the light diffuser plate of the present invention is advantageously used in a surface light source, the application thereof is not limited to such one. While the surface light source of the present invention is advantageously used as a backlight for a liquid crystal display, the application thereof is not limited to such one.

1. A light diffuser plate with a light-collecting layer, comprising a light-diffusing substrate and a light-collecting sheet, which are disposed to be superposed on each other, wherein the light-diffusing substrate and the light-collecting sheet are jointed to each other by joint portions which are so disposed as to be scattered over a whole plane of the light diffuser plate, and wherein an air layer exists between the light-diffusing substrate and the light-collecting sheet in an area other than the joint portions.

2. The light diffuser plate with the light-collecting layer, according to claim 1, wherein the area of the joint portions in a planar view is from 0.01 to 5% of the superposed area of the light-diffusing substrate and the light-collecting sheet.

3. A surface light source comprising the light diffuser plate with the light-collecting layer, according to claim 1 or 2, and a plurality of light sources disposed on the rear side of the light diffuser plate, wherein the light-collecting sheet of the light diffuser plate is placed so as to face the front side of the surface light source.

4. A liquid crystal display comprising the light diffuser plate with the light-collecting layer, according to claim 1 or 2, a plurality of light sources disposed on the rear side of the light diffuser plate, and a liquid crystal panel disposed on the front side of the light diffuser plate, wherein the light-collecting sheet of the light diffuser plate is placed so as to face the front side of the liquid crystal display.
